(19) United States
(12) Patent Application Publication
(10) Pub. No.: US 2025/0316733 A1
(43) Pub. Date: Oct. 9, 2025

(54) METHOD FOR STARTING A COMPRESSOR ASSEMBLY OF A FUEL CELL SYSTEM

(71) Applicant: Robert Bosch GmbH, Stuttgart (DE)

(72) Inventors: Jochen Braun, Heimsheim (DE); Nicole Bayerle, Schwieberdingen (DE)

(21) Appl. No.: 18/865,057

(22) PCT Filed: May 10, 2023
(86) PCT No.: PCT/EP2023/062386

§ 371 Date: Nov. 12, 2024

(30) Foreign Application Priority Data
May 23, 2022 (DE) 10 2022 205 132.7

(51) Int. Cl. H01M 8/04746; H01M 8/04111; H01M 8/04302

(52) U.S. Cl. CPC H01M 8/04776; H01M 8/04111; H01M 8/04302; H01M 8/04753; H01M 2250/20

(57) ABSTRACT

The invention relates to a method for starting a compressor assembly of a fuel cell system, the compressor assembly comprising an electrically operable first compressor and a downstream second compressor, which is coupled, by means of a rotor, to a turbine disposed in a cathode path of the fuel cell system, and the method comprising the steps of starting the first compressor and accelerating the first compressor to a first rotational speed at least corresponding to an idling rotational speed of the first compressor, selecting a first rotational speed gradient from a first and a second rotational speed gradient value, wherein the first rotational speed gradient value exceeds the second rotational speed gradient value, accelerating the first compressor from the first rotational speed to a second rotational speed with the first rotational speed gradient, examining, during the acceleration to the second rotational speed, whether the rotor rotates freely or whether the rotor is blocked, accelerating the first compressor to a maximum starting rotational speed by means of a second rotational speed gradient if the rotor rotates freely, or maintaining the second rotational speed, examining the rotation again and accelerating the first compressor to the maximum starting rotational speed if the rotor rotates freely, wherein the first rotational speed gradient value is selected from environmental and operating parameters of the fuel cell system if it is more probable that a rotor of the turbine is not blocked, and wherein the second rotational speed gradient value is selected if it is more probable that the rotor of the turbine is blocked.

### BACKGROUND

The present invention relates to a method for starting a compressor assembly of a fuel cell system and to a fuel cell system with a compressor assembly which can be operated by means of the method.

In vehicles in which at least part of the electrical power required for an electric drive is provided by a fuel cell system, compressors are usually integrated for compressing and supplying ambient air to the fuel cell system. Numerous different compressor assemblies are known, which are single-flow, double-flow, single-stage or multi-stage. Thermal turbomachines are often used as compressors. A two-stage compressor assembly comprises, for example, a first compressor with an electric drive. A downstream second compressor could be driven by a turbine disposed in a cathode path and, in particular, an outgoing air path of the fuel cell system. The first compressor and the second compressor as well as the turbine driving the second compressor are often supported by air bearings, which require a minimum rotational speed to build up the corresponding air layer.

Due to the diverse operating conditions of a fuel cell vehicle, situations can arise in which, for example, the rotor between the turbine and the second compressor becomes stuck, for example due to corrosion caused by the vehicle being stationary for a long period of time or due to icing at low ambient temperatures. However, commissioning the fuel cell system requires a quick and reliable start of the compressor assembly, taking into account all operating limits, in order to prevent damage or excessive wear.

### SUMMARY

The task of the invention is to propose an alternative method for operating a compressor assembly which enables reliable and rapid starting of the compressor assembly even under a wide variety of operating conditions, and also adaptation to different operating restrictions.

A method for starting a compressor assembly of a fuel cell system is proposed, the compressor assembly having at least one electrically operable first compressor and a downstream second compressor which is coupled via a rotor to a turbine disposed in a cathode path of the fuel cell system, the method having the steps of starting the at least one first compressor and accelerating the at least one first compressor to a first rotational speed which corresponds to at least one idling rotational speed of the at least one first compressor, selecting a first rotational speed gradient from a first and a second rotational speed gradient value, wherein the first rotational speed gradient value exceeds the second rotational speed gradient value, accelerating the at least one first compressor from the first rotational speed to a second rotational speed with the first rotational speed gradient, examining during the acceleration to the second rotational speed whether the rotor rotates freely or whether the rotor is blocked, accelerating the at least one first compressor to a maximum starting rotational speed using a second rotational speed gradient when the rotor is rotating freely, or maintaining the second rotational speed, repeatedly examining the rotation and accelerating the at least one first compressor to the maximum starting rotational speed, when the rotor is rotating freely, wherein the first rotational speed gradient value is selected from environmental and operating parameters of the fuel cell system when it is more probable that a rotor of the turbine is not blocked, and wherein the second rotational speed gradient value is selected when it is more probable that the rotor of the turbine is blocked.

The compressor assembly here is a two-stage assembly, wherein the first stage comprises one or more electrically operable first compressors and the second stage comprises a second compressor following downstream. The second compressor is connected via a rotor to a turbine, which is fed in particular with outgoing air from the fuel cell system. If there is sufficient outgoing air flow, the turbine drives the compressor via the rotor, provided the rotor is not blocked. This can refer to single and multi-flow first and/or second compressors.

The method according to the invention begins with the starting of the at least one first compressor, which is accelerated from standstill to the first rotational speed, for example. If a start of the compressor assembly overlaps with a run-down of the compressor assembly after an immediately preceding shutdown, the first compressor can also be accelerated to the first rotational speed from a higher rotational speed than from standstill. The motor of the at least one first compressor can have power electronics which are designed to bring the gas or air bearings of the at least one first compressor out of a mechanical friction range as quickly as possible via the lift-off rotational speed into purely aerodynamic operation in order to protect the respective components. The idling rotational speed of the at least one first compressor significantly exceeds this lift-off rotational speed and the at least one first compressor can then be operated reliably and safely over the long term.

The fuel cell system could still be in a switched-off state when at least one of the first compressors is commissioned. Air supplied into the cathode path by the at least one first compressor enters the outgoing air path of the fuel cell system via an open cathode bypass path into the turbine of the second compressor. However, the rotor could be blocked for the reasons mentioned. To take this into account, the first rotational speed gradient is selected by estimating, based on environmental and operating parameters, whether the rotor is fixed or free to rotate with a certain probability. The rotor is presumably free to rotate when the fuel cell system or the compressor assembly has carried out a warm start or the fuel cell system has only been idle for a short time. The same could also be the case with start-stop operation. On the other hand, a blocked rotor could be expected if a freeze start is carried out or if there are very long downtimes, which could corrode the bearings of the rotor.

If it can be assumed that the rotor is not blocked, the first compressor can be accelerated to the second rotational speed with a greater acceleration. However, the acceleration is lower if the rotor is presumably stationary. This can counteract any pumping of the at least one first compressor and also limit a thermal gradient in the compressor assembly.

During acceleration to the second rotational speed, the invention examines whether the rotor is turning. If the rotor is not blocked, the first compressor can then be accelerated to its maximum starting rotational speed so that the turbine and the second compressor are accelerated to the maximum. The acceleration of the at least one first compressor can be carried out with the greatest possible rotational speed gradient. The maximum starting rotational speed specified here can correspond to a maximum permissible rotational speed predetermined for the at least one first compressor or a maximum rotational speed specified for the start that is below the maximum permissible rotational speed.

By increasing the rotational speed of the at least one first compressor and, as explained below, the position of other elements influencing the flow, a sufficiently high torque is applied to break the rotor free from the static friction of the bearings and then accelerate the rotor as quickly as possible. In addition to achieving good dynamics, this also ensures that a minimum rotational speed of the rotor is exceeded as quickly as possible, which has a significant advantage for the gas bearings in terms of component protection, as the lift-off rotational speed is exceeded as quickly as possible.

If it is determined during the examining that the rotor is blocked, the rotational speed of the at least one first compressor is limited to the second rotational speed so that pumping is prevented. In the case of a blocked rotor, the turbine generates an additional pressure loss in the cathode path, so that a throttling downstream of the at least one first compressor is greater than under normal operating conditions and the operating points of the at least one first compressor can come closer to a pumping characteristic curve. In the meantime, you can continue to examine whether the rotor is turning freely, which could be the case particularly if the rotor is frozen. Remaining at the second rotational speed leads to an operating restriction of the fuel cell system, such as emergency operation.

As explained below, the first rotational speed gradient value and the second rotational speed gradient value are not necessarily each a constant, but could also be dependent on other parameters.

In an advantageous embodiment, the method further comprises closing a turbine bypass before or immediately after starting the at least one first compressor. This achieves the greatest possible acceleration of the rotor, as the entire air mass flow is guided through the turbine and the inlet pressure of the turbine is increased.

In an advantageous embodiment, the method further comprises opening a fuel cell bypass before or immediately after starting the at least one first compressor, wherein the fuel cell bypass directs compressed incoming air upstream of a cathode inlet of the fuel cell system into an outgoing air path upstream of the turbine. A pressure loss resulting from the flow through a fuel cell stack can thus be prevented and the maximum possible pressure is applied to the turbine. In addition, any existing throttle valves can be opened to counteract a further reduction in pressure.

In the predominant embodiments, the compressor assembly is preferably started while the cathode path of the fuel cell stack is still closed off by shut-off devices. In this case, it is necessary to open the cathode bypass path.

In an advantageous embodiment, the second rotational speed gradient value is variable and decreases with decreasing ambient temperature or decreasing temperature within the compressor assembly. This limits the temperature gradient generated by the heating of the cathode path by compressed air.

In an advantageous embodiment, the second rotational speed is selected in such a way that pumping of the at least one first compressor is prevented when the rotor is blocked. The second rotational speed should therefore not be too high in order to prevent pumping in the event of excessive pressure loss in the cathode path. However, the second rotational speed should not be too low to allow a blocked rotor to be released. The examining step cannot be carried out at rotational speeds of the at least one first compressor that are too low, for example below or around an idling rotational speed, since, for example, pressure sensors are fitted before/after the turbine or before/after the second compressor and must evaluate a specific pressure level or a pressure ratio or a pressure difference across the turbine and/or across the second compressor and the pressure sensor tolerances must be taken into account here.

In an advantageous embodiment, the acceleration of the at least one first compressor to the second rotational speed takes place in a plurality of rotational speed stages, each of which is maintained for a predetermined time interval, wherein the examination takes place during the time interval. Temporary stationary operating points can be used in particular to measure a pressure drop across the turbine and/or the second compressor more accurately.

In an advantageous embodiment, the method further comprises adopting a predetermined or predeterminable operating rotational speed by the at least one first compressor when the rotor has reached at least a minimum rotational speed of the rotor, or, if the rotor is blocked, maintaining an operating restriction of the fuel cell system and adopting the predetermined or predeterminable operating rotational speed while limiting it to a restricted maximum rotational speed. The restricted maximum rotational speed is below the maximum starting rotational speed and also represents the upper limit in continued operation as long as the rotor is blocked. This terminates the starting of the compressor assembly and initiates normal or restricted operation of the fuel cell system. The minimum rotational speed of the rotor takes particular account of the lift-off rotational speed for the gas bearings of the turbine or rotor. If restricted operation of the fuel cell system and the compressor assembly is initiated, the examination step is repeated continuously until the rotor turns freely.

The invention also relates to a fuel cell system having a fuel cell stack, a compressor assembly which has at least one electrically operable first compressor and a downstream second compressor which is coupled via a rotor to a turbine arranged in a cathode path of the fuel cell system, and a control unit for controlling the fuel cell system, wherein the fuel cell system is designed for this purpose, executing a method for starting the compressor assembly by means of the control unit, the method comprising the steps of starting the at least one first compressor and accelerating the at least one first compressor to a first rotational speed which corresponds to at least one idling rotational speed of the at least one first compressor, selecting a first rotational speed gradient from a first and a second rotational speed gradient value, wherein the first rotational speed gradient value exceeds the second rotational speed gradient value, accelerating the at least one first compressor from the first rotational speed to a second rotational speed with the first rotational speed gradient, during acceleration to the second rotational speed, examining whether the rotor is spinning freely or whether the rotor is blocked, accelerating the at least one first compressor to a maximum starting rotational speed using a second rotational speed gradient if the rotor is spinning freely, or maintaining the second rotational speed, repeatedly examining the rotation and accelerating the at least one first compressor to the maximum starting rotational speed, when the rotor is rotating freely, wherein the first rotational speed gradient value is selected from environmental and operating parameters of the fuel cell system when it is more probable that the rotor of the turbine is not blocked, and wherein the second rotational speed gradient value is selected when it is more probable that the rotor of the turbine is blocked.

In an advantageous embodiment, the fuel cell system further comprises a turbine bypass, wherein the control unit is designed to close the turbine bypass before or immediately after starting the at least one first compressor.

In an advantageous embodiment, the fuel cell system further comprises a fuel cell bypass, wherein the control unit is designed to open the fuel cell bypass before or immediately after starting the at least one first compressor.

Further measures for improving the invention are described in greater detail hereinafter, together with the description of the preferred exemplary embodiments of the invention, with reference to the figures.

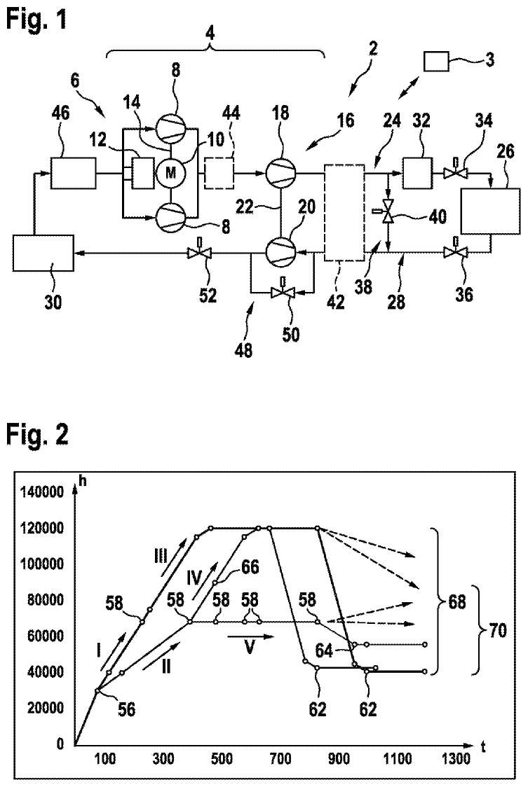

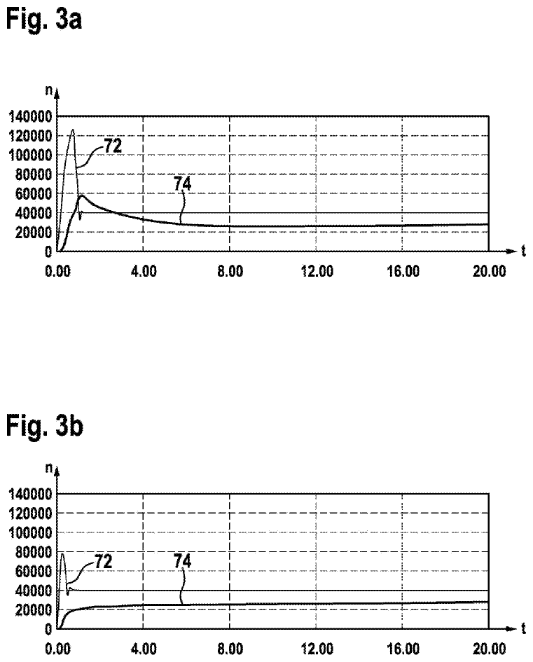

BRIEF DESCRIPTION OF THE DRAWINGS
Shown are:

| | |
|---|---|
| FIG. 1 | a fuel cell system. |
| FIG. 2 | a diagram with different sequences of a method. |
| FIGS. 3a | and 3b two diagrams with different rotational speed boost. |

### DETAILED DESCRIPTION

FIG. 1 shows a fuel cell system 2 that is controlled via a control unit 3. The fuel cell system 2 has a compressor assembly 4, which comprises a first compressor unit 6 with two first compressors 8, an electric motor 10 and an inverter 12. Both first compressors 8 are connected via a shaft 14 to the motor 10, which is supplied with an operating voltage via the inverter 12. The inverter 12 could be controlled externally to adjust the rotational speed of the motor as required.

The compressor assembly 4 also has a second compressor unit 16 with a second compressor 18 and a turbine 20, which are coupled together by a rotor 22. The second compressor 16 is located downstream of the first compressor 8 and supplies compressed air into an incoming air path 24 of a fuel cell stack 26. Outgoing air from the fuel cell stack 26 flows into an outgoing air path 28 and from there into the turbine 20. The outgoing air can then flow downstream of the turbine 20 into the environment 30. The incoming air path 24 and the outgoing air path 28 can be combined as a cathode path. An intercooler 32 is also provided downstream of the second compressor 18, which cools the compressed incoming air before it enters the fuel cell stack 26. A first shut-off valve 34 is located downstream of the intercooler 32, which shuts off the incoming air flow into the fuel cell stack 26 as required. A second shut-off valve 36 is located downstream of the fuel cell stack 26 for interrupting a connection between the fuel cell stack 26 and the outgoing air path 28 as required. The fuel cell stack 26 can be bypassed via a fuel cell bypass 38. The fuel cell bypass 38 has a fuel cell bypass valve 40 that can be opened and closed as required. A further heat exchanger 42 can be provided between the fuel cell stack 26 and the second compressor unit 16, which transfers heat from the incoming air path 24 to the outgoing air path 28. An additional intercooler 44 could also be disposed between the first compressor unit 6 and the second compressor unit 16, which cools the air flowing into the second compressor 18. An air filter 46 is disposed upstream of the first compressor unit 6, which filters air from the environment 30 and feeds it to the first compressor unit 6. The turbine 20 can be bypassed by a turbine bypass 48. The turbine bypass 48 has a turbine bypass valve 50 that can be opened and closed as required. An outgoing air shut-off valve 52 is also provided downstream of the turbine 20.

Controlled by the control unit 3, the fuel cell system 2 is able to carry out a method for starting the compressor assembly 4. The first compressors 8 are started and accelerated to a first rotational speed that corresponds at least to an idling rotational speed of the first compressors 8. A first rotational speed gradient is selected from a first and a second rotational speed gradient value, wherein the first rotational speed gradient value exceeds the second rotational speed gradient value. As explained above, the rotational speed gradient value is selected on the basis of an evaluation of the environmental and operating parameters of the fuel cell system 2. If it is more probable that the rotor 22 of the turbine 20 is not blocked, the first rotational speed gradient value is selected. If it is more probable that the rotor 22 of the turbine 20 is blocked, the second rotational speed gradient value is selected.

The first compressors 8 are accelerated from the first rotational speed to a second rotational speed with the first rotational speed gradient. During acceleration to the second rotational speed, it is examined whether the rotor 22 is rotating freely or whether it is blocked. The first compressors 8, when the rotor is rotating freely, are then accelerated to a maximum starting rotational speed by means of a second rotational speed gradient or the second rotational speed is maintained when the rotor 22 is blocked, wherein the rotation of the rotor 22 is examined repeatedly. The first compressors 8 are accelerated to the maximum starting rotational speed if the repeated examination reveals that the rotor 22 is rotating freely.

During start-up, the fuel cell bypass 38 can be open and the turbine bypass 48 can remain closed. If necessary, the first shut-off valve 34 and the second shut-off valve 36 could also be closed and the outgoing air shut-off valve 52 fully opened.

FIG. 2 shows a diagram in which the rotational speed of the first compressor 8 is plotted against time. Different scenarios are shown there. Initially, the first compressors 8 are at standstill 54, i.e. at zero rotational speed. The first compressors 8 are then accelerated to a first rotational speed 56. This is always done with the same, preferably maximum, rotational speed gradient. After reaching the first rotational speed 56, the first rotational speed gradient is selected. A first rotational speed gradient value is selected if it is more probable, based on the environmental and/or operating parameters of the fuel cell system 2, that the rotor 22 is freely rotatable. Then the first compressors 8 are accelerated to a second rotational speed 58 by means of the first rotational speed gradient value (path I). If, on the other hand, it is more probable that the rotor 22 is blocked, it is accelerated to the second rotational speed 58 with a lower, second rotational speed gradient value (path II). During acceleration to the second rotational speed 58, it is examined whether the rotor 22 is rotating. If this is the case, the system accelerates to a maximum starting rotational speed 60, wherein a maximum rotational speed gradient is selected (path III and path IV) regardless of the previous assessment of the condition of the rotor 22. However, if it is determined that the rotor 22 is blocked, the second rotational speed 58 is maintained wherein it is repeatedly examined whether the rotor 22 rotates freely. This is marked with the path V.

After reaching the maximum starting rotational speed 60 or after repeatedly detecting that the rotor 22 is blocked, the first compressors 8 assume an idling rotational speed. In the case of the rotating rotor 22, an idling rotational speed 62 is preferably lower than an idling rotational speed 64 when the rotor 22 is blocked. The idling rotational speed 64 is preferably sufficiently high to allow a previously blocked rotor 22 that has become loose to be started. However, the idling rotational speed 64 with blocked rotor 22 is lower than a maximum permissible rotational speed 66 with blocked rotor 22.

The idling rotational speed 62 is sufficiently high to ensure that the rotating rotor 22 maintains at least its minimum required rotational speed in order to protect the gas bearing of the rotor 22.

The idling rotational speed 62 is also greater than or equal to the minimum permissible rotational speed of the rotor 14 in order to protect the gas bearing of the rotor 14.

The dashed line indicates that a transition can also be made directly to a load point. When the rotor 22 is freely rotating, a first operating range 68 is larger than a second operating range 70 when the rotor 22 is blocked.

FIGS. 3a and 3b show the results of the simulation of two starting processes, in each of which it is assumed that the rotor 22 rotates freely. In FIG. 3a, a fairly high maximum starting rotational speed of the first compressors 8 is assumed, wherein the rotational speed curve of the first compressors 8 is marked with the reference sign 72. The resulting rotational speed curve 74 of the rotor 22 remains zero for a very short time until a breakaway torque is overcome, after which the rotational speed of the rotor 22 increases continuously. In FIG. 3b, the maximum starting rotational speed of the first compressor 8 is slightly lower so that the rotational speed of the rotor 22 increases somewhat more slowly. FIG. 3a shows a significantly greater increase in the rotational speed of the first compressor 8, which leads to a recognizable increase and greater acceleration of the rotational speed of the rotor 22.

1. A method for starting a compressor assembly (4) of a fuel cell system (2), the compressor assembly (4) having at least one electrically operable first compressor (8) and a downstream second compressor (18) which is coupled via a rotor (22) to a turbine (20) disposed in a cathode path of the fuel cell system (2), the method having the steps:
starting the at least one first compressor (8) and accelerating the at least one first compressor (8) to a first rotational speed (56) which corresponds at least to an idling rotational speed of the at least one first compressor (8),
selecting a first rotational speed gradient from a first and a second rotational speed gradient value, wherein the first rotational speed gradient value exceeds the second rotational speed gradient value,
accelerating the at least one first compressor (8) from the first rotational speed (56) to a second rotational speed (58) with the first rotational speed gradient,
during acceleration to the second rotational speed, examining whether the rotor (22) rotates freely or whether the rotor (22) is blocked,
accelerating the at least one first compressor (8) to a maximum starting rotational speed (60) by means of a second rotational speed gradient when the rotor (22) is rotating freely, or maintaining the second rotational speed (58), repeatedly examining the rotation and accelerating the at least one first compressor (8) to the maximum starting rotational speed (60) when the rotor (22) is rotating freely,
wherein the first rotational speed gradient value is selected from environmental and operating parameters of the fuel cell system (2) when it is more probable that a rotor (22) of the turbine (20) is not blocked, and wherein the second rotational speed gradient value is selected when it is more probable that the rotor (22) of the turbine (20) is blocked.

2. The method according to claim 1, further comprising:
closing a turbine bypass (48) before or immediately after starting the at least one first compressor (8).

3. The method according to claim 1, further comprising:
opening of a fuel cell bypass (40) before or immediately after starting the at least one first compressor (8), wherein the fuel cell bypass (40) directs compressed incoming air upstream of a cathode inlet of the fuel cell system (2) into an outgoing air path (28) upstream of the turbine (20).

4. The method according to claim 1,
wherein the second rotational speed gradient value is variable and decreases with decreasing ambient temperature or decreasing temperature within the compressor assembly (4).

5. The method according to claim 1,
wherein the second rotational speed is selected such that pumping of the at least one first compressor (8) is prevented when the rotor (22) is blocked.

6. The method according to claim 1,
wherein the acceleration of the at least one first compressor (8) to the second rotational speed (58) takes place in a plurality of rotational speed stages, each of which is maintained for a predetermined time interval, wherein the examination takes place during the time interval.

7. The method according to claim 1, further comprising:
adopting of a predetermined or predeterminable operating rotational speed by at least one first compressor (8), when the rotor (22) has reached at least a minimum rotor rotational speed, or, if the rotor (22) is blocked, maintaining an operating restriction of the fuel cell system (2) and adopting the predetermined or predeterminable operating rotational speed while limiting it to a restricted maximum rotational speed.

8. A fuel cell system (2), comprising:
a fuel cell stack (26),
a compressor assembly (4) which has at least one electrically operable first compressor (8) and a downstream second compressor (18) which is coupled via a rotor (22) to a turbine (20) disposed in a cathode path of the fuel cell system (2), and
a control unit (3) for controlling the fuel cell system (2), wherein the fuel cell system (2) is configured to execute a method for starting the compressor assembly (4) by means of the control unit (3), the method comprising the steps:
starting the at least one first compressor (8) and accelerating the at least one first compressor (8) to a first rotational speed (56) which corresponds at least to an idling rotational speed of the at least one first compressor (8),
selecting a first rotational speed gradient from a first and a second rotational speed gradient value, wherein the first rotational speed gradient value exceeds the second rotational speed gradient value,
accelerating the at least one first compressor (8) from the first rotational speed (56) to a second rotational speed (58) with the first rotational speed gradient,
during acceleration to the second rotational speed (58), examining whether the rotor (22) rotates freely or whether the rotor (22) is blocked,
accelerating the at least one first compressor (8) to a maximum starting rotational speed (60) by means of a second rotational speed gradient when the rotor (22) is rotating freely, or maintaining the second rotational speed (58), repeatedly examining the rotation and accelerating the at least one first compressor (8) to the maximum starting rotational speed (60) when the rotor (22) is rotating freely,
wherein the first rotational speed gradient value is selected from environmental and operating parameters of the fuel cell system (2) when it is more probable that the rotor (22) of the turbine (20) is not blocked, and
wherein the second rotational speed gradient value is selected when it is more probable that the rotor (22) of the turbine (20) is blocked.

9. The fuel cell system according to claim 8, further comprising:
a turbine bypass (50),
wherein the control unit (3) is configured to close the turbine pass (50) before or immediately after starting the at least one first compressor (8).

10. The fuel cell system according to claim 8, further comprising:
a fuel cell bypass (38),
wherein the control unit (3) is configured to open the fuel cell bypass (38) before or immediately after starting the at least one first compressor (8).
